(19) United States
(12) Patent Application Publication
(10) Pub. No.: US 2011/0215220 A1
(43) Pub. Date: Sep. 8, 2011

(54) CATALYTIC CONVERTER FASTENING FOR A COMBUSTION ENGINE

(75) Inventor: Arnold LOEBIG, Weiterstadt (DE)

(73) Assignee: GM GLOBAL TECHNOLOGY OPERATIONS LLC, Detroit, MI (US)

(21) Appl. No.: 13/040,577

(22) Filed: Mar. 4, 2011

(30) Foreign Application Priority Data
Mar. 5, 2010 (DE) 102010010397.7

(51) Int. Cl. F16M 13/02

(52) U.S. Cl. 248/674

(57) ABSTRACT

A catalytic converter fastening is provided for a combustion engine. The catalytic converter fastening includes, but is not limited to an engine block bracket that is releasably connected to an engine block. The engine block bracket fixes the catalytic converter at a distance to the engine block. A catalytic converter support is materially connected to the catalytic converter, and connecting elements releasably connect the engine block bracket to the engine block. The catalytic converter support comprises at least one arm angled-off towards the engine block bracket, while on the arm at least one angled-off strap is arranged. The strap is materially connected to a catalytic converter housing. Here, the catalytic converter fastening of engine block bracket and catalytic converter support is of the unitary type.

### CROSS-REFERENCE TO RELATED APPLICATION

This application claims priority to German Patent Application No. 102010010397.7, filed Mar. 5, 2010, which is incorporated herein by reference in its entirety.

### TECHNICAL FIELD

The technical field relates to a catalytic converter fastening for a combustion engine. A catalytic converter fastening comprises an engine block bracket that is releasably connected to an engine block. The engine block bracket fixes the catalytic converter at a distance to the engine block.

### BACKGROUND

A catalytic converter fastening is known from the publication DE 10 2004 023 585 B4 for a combustion engine. In addition to this, the known catalytic converter fastening comprises an engine block bracket (for fastening to a combustion engine) and a catalytic converter bracket for fastening to a catalytic converter. Finally, the catalytic converter fastening comprises connecting means for connecting engine bracket and catalytic converter bracket. The catalytic converter bracket is designed so that it can be fixed to a flange of the catalytic converter.

The known catalytic converter fastening on the one hand requires that a suitably prepared flange of the catalytic converter is available. However, this is not always the case, particularly not if it is an exhaust manifold catalytic converter with which the catalytic converter is fixed on the exhaust manifold, while the catalytic converter for example is arranged vertically and parallel to the engine block and without flange merges into an exhaust pipe of an exhaust system. A further disadvantage of the known catalytic converter fastening comprises in that it is composed of at least two parts, namely an engine block bracket and a catalytic converter bracket, which are held together via connecting screws, so that a plurality of individual elements is required in order to assemble this catalytic converter fastening. Through the multiplicity of individual parts for this catalytic converter fastening, additional storage costs are incurred in addition to the high assembly costs in order to keep the appropriate parts in stock and ready for the production.

At least one object is to create a catalytic converter fastening for a combustion engine that is more cost-effectively to assemble and requires lower storage costs. In addition to this, the catalytic converter fastening is to compensate for manufacturing tolerances and thermal expansion differences. In addition, other objects, desirable features and characteristics will become apparent from the subsequent summary and detailed description, and the appended claims, taken in conjunction with the accompanying drawings and this background.

### SUMMARY

A catalytic converter fastening is provided for a combustion engine is created in an embodiment having an engine block bracket that is releasably connected to an engine block. The engine block bracket fixes the catalytic converter at a distance to the engine block. A catalytic converter support is materially connected to the catalytic converter. Connecting elements releasably connect the engine block bracket with the engine block. The catalytic converter support comprises at least one arm angled off towards the engine block bracket. On the arm at least one angled-off strap is arranged. The strap is connected to a catalytic converter housing. Here, the catalytic converter fastening of engine block bracket and catalytic converter support is a unitary part.

This catalytic converter fastening has the advantage that merely a single part is necessary in order to reliably fix the catalytic converter to the engine block. This unitary state additionally has the advantage that not only stock holding and the assembly costs can be reduced, but that a substantial part of screw connections is saved and the reliability of the assembly is increased, more so since the risk of unintentional loosening of screw connections is diminished through the reduction of the number of screw fastenings.

In addition to this, by forming an S-shaped arm that is arranged angled-off to the engine block bracket, the elasticity of the catalytic converter fastening can be increased and thus decoupling of vibrations between engine block and catalytic converter can be achieved. The resilience of the angled-off arm can also be increased through the provision of corresponding relief holes in the angled-off arm, in order to further reduce effects of vibrations of the engine block on the catalytic converter. In addition, it is provided that the at least one strap of the catalytic converter support is matched to the contour of the catalytic converter housing so that the transition from the strap to the catalytic converter housing can be welded without problems. On the other hand it is also provided that the catalytic converter support comprises several straps in order to distribute the forces over the catalytic converter housing.

In addition, the engine block bracket is matched to the contour of the engine block in order to ensure an accurately fitting material connection between engine block and engine bracket. With the material connection of the catalytic converter housing with the straps of the catalytic converter fastening for example through welding or brazing, catalytic converter and catalytic converter fastening form an assembly module that can be cost-effectively assembled and in the event of repair, cost-effectively replaced.

In order to connect the engine block bracket with the engine block via connecting elements, the engine block bracket comprises bores or elongated holes through which the connecting elements engage and press the engine block bracket against the engine block. Here, the connecting elements in the bores or elongated holes of the engine block bracket can have a clearance fit or a press fit.

To compensate for manufacturing tolerances of the catalytic converter fastening and for compensating thermal expansion differences the connecting elements have compensating washers which are arranged in the bores or elongated holes for receiving the connecting elements. Such compensating washers are matched with their outer contour to the inner contour of the bores or elongated holes and can be produced of a soft or hard plastic or an elastic metal alloy in order to make possible the compensating of manufacturing tolerances or the compensating of heat expansion differences.

The thickness of the compensating washers is greater than the thickness of the engine block bracket, while the contour of the compensating washers overlaps a marginal region of the bores or elongated holes in order to ensure that the bores or elongated holes are filled out by the compensating washers except for a central hole through which a connecting screw engages and the connecting element of connecting screw and a press washer fixes the engine block bracket to the engine block via the compensating washer. Compensating washers of plastic can also be cast into the bores or elongated holes of the engine block bracket.

In addition, it is provided that elongated holes in the engine block bracket are open vertically downwards and the engine block bracket can be pushed onto the connecting elements on the engine block with the elongated holes open towards the bottom. This has the advantage that the assembly of the engine block bracket is simplified more so since inserting connecting elements through corresponding bores of the engine block bracket provided with compensating washers is not required.

In addition, it is provided that on the engine block bracket space-holding molded-on passages or welded-on bushings are arranged in the region of fastening openings of the engine block bracket. These welded-on bushings or molded-on passages allow reducing the heat connection between engine block bracket and engine block. Furthermore, a spacing between engine block and engine block bracket is created that makes possible an improved cooling air flow. For compensating manufacturing tolerances of the catalytic converter fastening and for compensating heat expansion differences cylindrical compensating elements of a plastic or a metal alloy are arranged in the space-holding molded-on passages or welded-on bushings.

In addition, the space-holding and molded-on passages or welded-on bushings can have inner threads and the cylinder-shaped compensating elements be provided with outer threads so that it is possible to screw the compensating elements in the molded-on passages or welded-on bushings. To this end, the cylinder-shaped compensating elements can have an inner hexagonal opening so that with the help of an Allen key. The cylinder-shaped compensating elements can be screwed into the space-holding molded-on passages or welded-on bushings. With the compensating elements that can be screwed in the spacing between engine block and engine block bracket can additionally be readjusted in a compensating manner. Preferentially, such catalytic converter fastenings are employed for catalytic converters of combustion engines, while unitary catalytic converter fastenings are particularly suitable for combustion engines with exhaust manifold catalytic converters.

### BRIEF DESCRIPTION OF THE DRAWINGS

The present invention will hereinafter be described in conjunction with the following drawing figures, wherein like numerals denote like elements, and

FIG. 1 shows a schematic perspective part view of a catalytic converter which with the help of a catalytic converter fastening according to a first embodiment is fixed on an engine block;

FIG. 2 shows a schematic perspective view of the catalytic converter fastening according to FIG. 1 in detail;

FIG. 3 shows a schematic perspective view of a catalytic converter fastening according to a second embodiment;

FIG. 4 shows a schematic perspective view of a catalytic converter fastening according to a third embodiment; and

FIG. 5 shows a schematic perspective view of the catalytic converter fastening according to FIG. 4 from a changed viewing angle.

### DETAILED DESCRIPTION

The following detailed description is merely exemplary in nature and is not intended to limit application and uses. Furthermore, there is no intention to be bound by any theory presented in the preceding background or summary or the following detailed description.

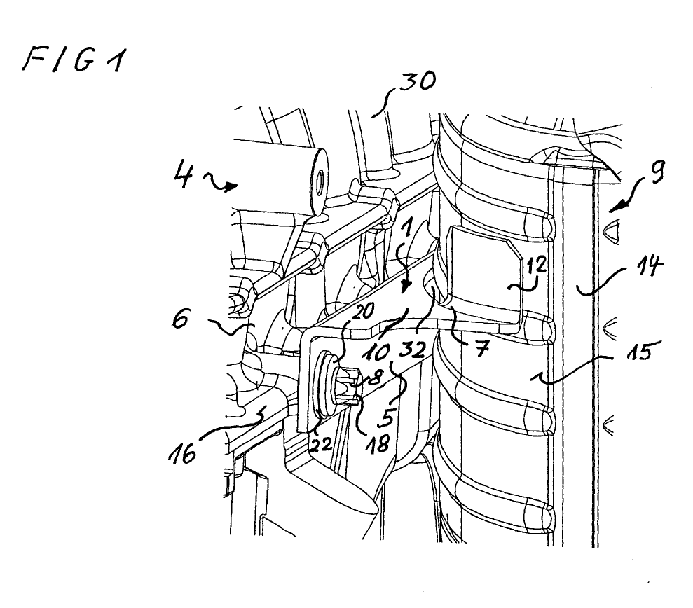

FIG. 1 shows a schematic perspective part view of a catalytic converter 9, which with the help of a catalytic converter fastening 1 according to a first embodiment of the subject of the application is fixed on an engine block 6. The engine block 6 belongs to a combustion engine 4, which above the engine block 6 comprises a cylinder head 30 to which an exhaust manifold that is not shown here is connected, whose exhaust gases are initially conducted into the catalytic converter 9. Accordingly, the exhaust gases are extremely hot and the catalytic converter 9 has a reaction temperature in its interior of approximately 800° C. The engine block 6 by comparison is water-cooled and has an outer operating temperature below approximately 300° C.

Next to the unavoidable manufacturing tolerances for a catalytic converter fastening 1 problems of the different thermal expansions of engine block 6, catalytic converter 9 and exhaust manifold have to be solved by such a catalytic converter fastening 1 above all. This is further aggravated in that the application for the cost reduction provides for a unitary catalytic converter fastening 1, as shown in FIG. 1. In the embodiment of the application shown, the catalytic converter fastening 1 comprises an engine block bracket 5 which is releasably connected to the engine block 6.

The engine block bracket 5 fixes the catalytic converter 1 at a spacing from the engine block 6. A catalytic converter support 7 bridges this spacing and is materially connected to the catalytic converter 9. At least one connecting element 8 releasably connects the engine block bracket 5 to the engine block 6. In this perspective view merely one of two connecting elements 8 in form of screws 18 is visible. In order to thermally decouple the engine block bracket 1 from the hot catalytic converter housing 14 an arm 10 of the catalytic converter support 7 is visible in FIG. 1, which on the one side is angled-off at a right angle to the engine block bracket 5 arranged in a flat manner and with its cross-sectional surface compared with the cross-sectional surface of the engine block bracket 5 is reduced before the arm 10 merges into a strap 12 with which the catalytic converter support 7 is welded to the catalytic converter housing 14.

A second strap which is not shown here is provided on an opposite side of the catalytic converter housing 14. Between the straps a gap 32, which extends between catalytic converter fastening 1 and catalytic converter housing 14, is arranged. The gap 32 interrupts the heat flow between catalytic converter housing 14 and catalytic converter fastening 1. By this it is ensured that the heat loss, which flows to the engine block 6 via the strap 12, the arm 10 and the engine block bracket 5 is kept low. The heating-up of the engine block bracket 5 in the region of the connecting elements 8 is additionally reduced by this, since compensating washers 22 of plastic materials can be inserted or cast in, which additionally compensate for heat expansion differences and manufacturing tolerances.

While with the embodiment of the application shown in FIG. 1 the arm 10 is of a relatively stiff and horizontal design, the elasticity and resilience of the catalytic converter fastening 1 can be increased in that the arm 10 is produced S-shaped or provided with a hole pattern. A hole pattern additionally increases the thermal lag of the arm 10.

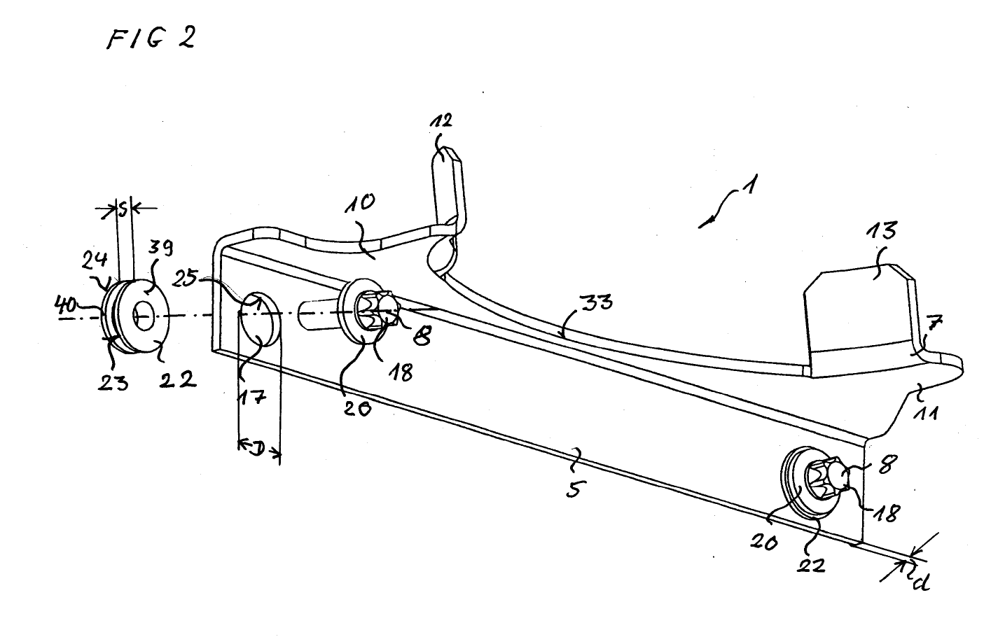

FIG. 2 shows a schematic perspective and partially expanded view of the catalytic converter fastening 1 according to FIG. 1 in detail. The shown catalytic converter fastening 1 now merely consists of a single part, without additional screw transitions between a catalytic converter support 7 and an engine block bracket 5. The catalytic converter fastening 1 thus no longer has seven parts if the connecting elements are added, but merely of three parts, namely the engine block bracket 5 and two connecting elements 8. The unitary catalytic converter fastening 1 on the engine bracket 5 comprises an angled-off left arm 10 and an angled-off right arm 11, at whose ends angled-off straps 12 and 13 as shown in FIG. 1. The straps 12 and 13 are matched to the contour 15 of the catalytic converter housing 14 so that they can be materially connected to the catalytic converter housing 14.

A clearance 33 between the straps 12 and 13 angled-off to the arms 10 and 11 forms the gap 32 shown in FIG. 1 for interrupting the heat flow between the catalytic converter housing 14 and the engine block. A further thermal blockage can be achieved in that compensating washers 22 are provided in bores 17 of the engine block bracket 5. These compensating washers 22 have a contour 23 on its outer circumference 24 which is matched to the inner contour 25 of bores 17 for the connecting elements 8.

The washer thickness s of the compensating washer 22 is greater than the thickness d of the engine block bracket 5. In addition, washer-shaped enlargements 39 and 40, which go beyond the diameter D of the bore 15 are provided on both sides of the compensating washer 22, so that the compensating washers 22 on the one hand can interrupt the thermal flow if the compensating washers 22 are produced of a suitable plastic and on the other hand compensate for different heat expansions and/or manufacturing tolerances.

Following the assembly of the compensating washer 22 in the bore 17 the plastic completely covers the inner contour of the bore 17 and the edges of the bore 17. In order to achieve a secure seat on the engine block eight screws 18 are provided as connecting elements which can be screwed into a blind threaded hole of the engine block. A thrust washer 20 on the screw head presses the compensating washers 22 with the engine block bracket 5 against the engine block when the fastening screw 18 is screwed in. In addition to interrupting the thermal flow and the compensating of manufacturing tolerances as well as heat expansion differences the compensating washer 22 additionally ensures damping of structure-borne sound and vibrations between engine block and engine block bracket 5 and thus between engine block and catalytic converter housing.

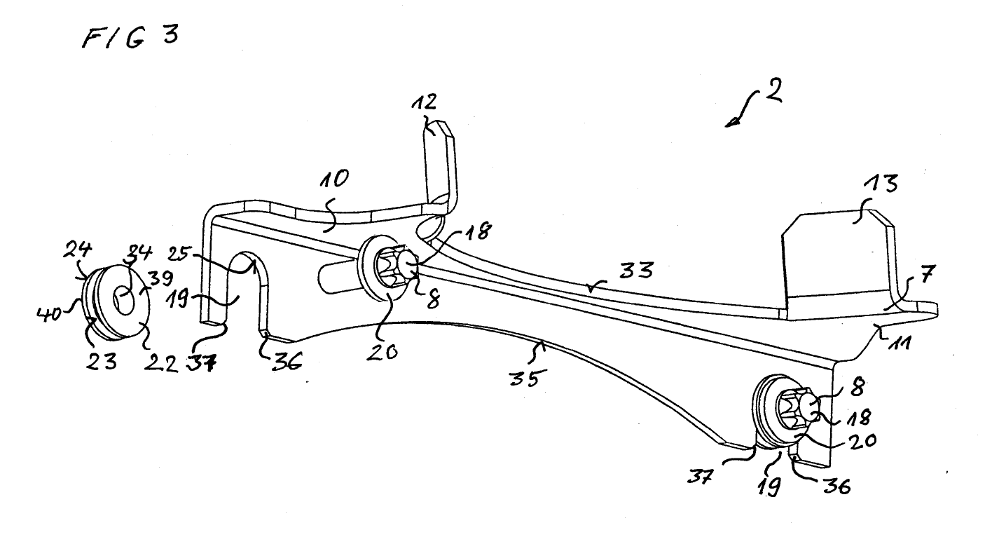

FIG. 3 shows a schematic perspective view of a catalytic converter fastening 2 according to a second embodiment. Components with same functions as in the preceding figures are marked with same reference characters and are not separately discussed. The difference of the catalytic converter fastening 2 according to the second embodiment to the first embodiment of the application in FIG. 2 is that instead of the bores 17 elongated holes 19 are now provided in order to position the connecting elements 8 towards the engine block. For the assembly of the compensating element 22 in the elongated hole 19 the elongated hole 19 at the inlet side has chamfers 36 and 37, which facilitate inserting the compensating washer 22 in the elongated hole 19, if the compensating washer 22 is initially pushed into the elongated hole 19 from below. In the process, the contour 23 of the compensating washer 22 adapts to the inner contour 25 of the elongated hole 19. Through an appropriate fit clearance, all manufacturing tolerances in the three space directions can be compensated.

Through subsequent insertion of the screw 18 with the thrust washer 20 as connecting element 8 through the central opening 34 of the compensating element 22 the catalytic converter fastening can then be fixed to the engine block by screwing on via the engine block bracket 5. A further difference between the second embodiment of the application shown in FIG. 3 compared with the first embodiment is an elongated clearance 35 of the engine block bracket which on the one hand improves the resilience of the engine block bracket 5 and on the other hand further diminishes the heat transition. In addition to this clearance 35, the arms 10 and 11 of the catalytic converter support 7 can also be improved in terms of resilience, elasticity and heat resistance through shaping and clearances.

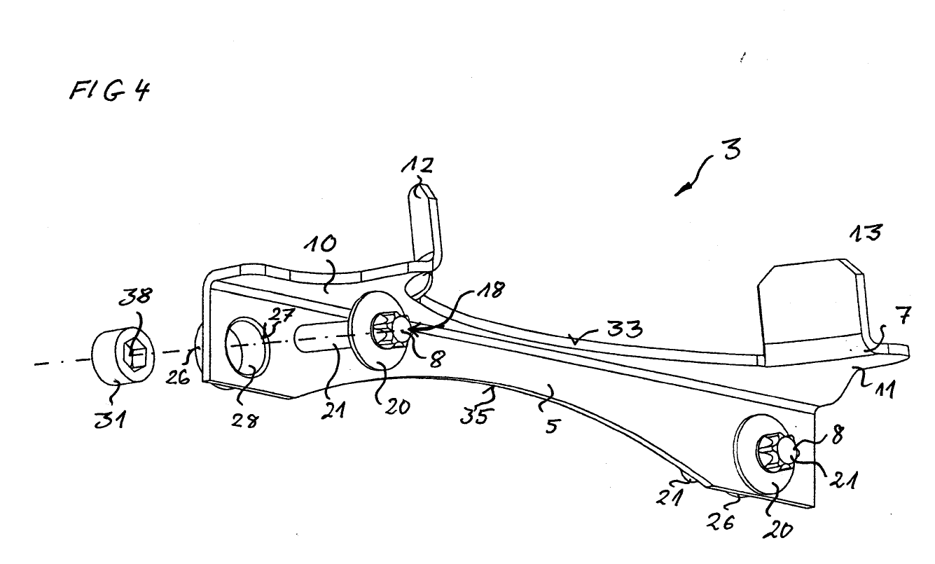

FIG. 4 shows a schematic perspective view of a catalytic converter fastening 3 according to a third embodiment. This catalytic converter fastening 3 is configured similarly to the preceding catalytic converter fastenings so that components with same functions as in the preceding figures are marked with the same reference number and are not separately discussed. The difference to the preceding embodiments consists in that instead of a simple bore or a simple elongated hole fastening openings 28 in the engine block bracket 5 are now provided for inserting the connecting elements 8 with the thrust washers 20. These fastening openings 28 in this third embodiment of the application are provided with molded passages or with welded-on bushings 26, so that the engine block bracket 5 gains an additional spacing to the engine block. Through this additional spacing the heat flow between catalytic converter and engine block is further prevented.

Additionally, in addition to the interruption or blocking of the heat flow, a compensation of the tolerances and the heat expansion differences is supported through cylinder-shaped plastic and/or metal compensating elements 31. These compensating elements 31 can be pushed into the fastening opening 28, for the purpose of which the fastening opening 28 has a chamfer 27 in order to facilitate this pushing-in. In addition, the fastening opening 28 can have an inner thread and the cylinder-shaped compensating element have an outer thread, so that the cylinder-shaped compensating element 31 can be screwed into the fastening opening 28. In order to ensure the screwing-in, the cylinder-shaped compensating element 31 comprises an internal hexagon 38, so that it is possible with an Allen key to screw the cylinder-shaped compensating element 31 with an outer thread into the inner thread of the fastening opening 28.

With the compensating element 31 the spacing between engine block and engine block bracket 5 can be additionally set or adjusted. With the help of a tensile screw, which at its head end likewise comprises a thrust washer 20, the catalytic converter fastening 3 can be screwed and fixed to the engine block. Thus the tensile screw 21 clamps the catalytic converter fastening 3 to the catalytic converter, while the catalytic converter is preferentially an exhaust manifold catalytic converter and in connection with the exhaust manifold. The compensating element 31 like the compensating washer can be produced of different materials such as for example metal or different plastics, which depending on requirement are softer or harder. The catalytic converter fastenings as shown in embodiments in the preceding figures, can be designed for all heat expansion directions in three space directions and make possible a greater clearance and tolerance compensation of the overall system. This is connected with the saving of additional parts compared with the catalytic converter fastenings known from the prior art.

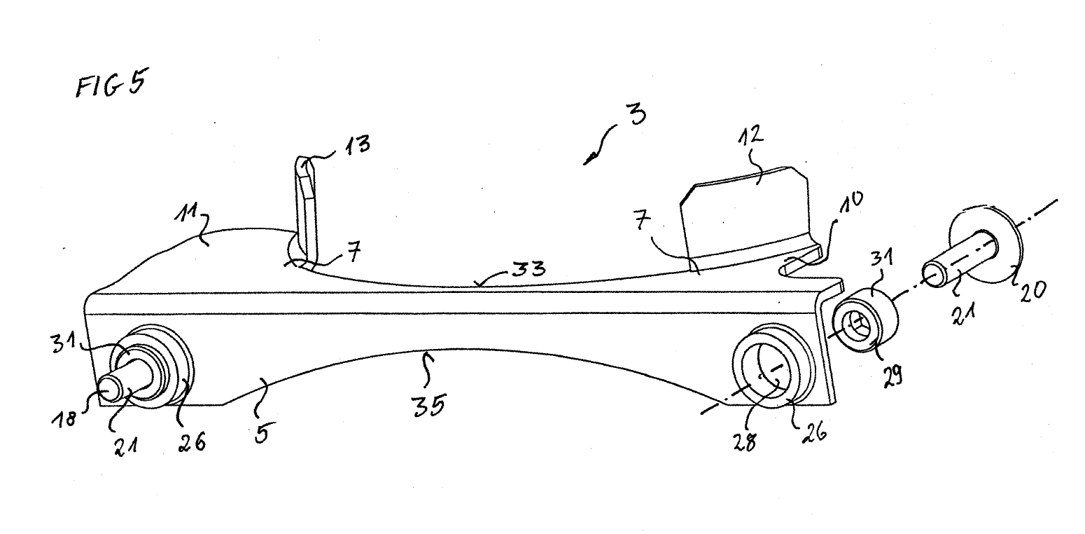

FIG. 5 shows a schematic perspective view of the catalytic converter fastening 3 according to FIG. 5 from a changed viewing angle. Components with same functions as in the preceding figures are marked with the same reference characters and are not separately discussed. From the viewing direction shown in FIG. 5 a chamfer 29 is visible on the compensating element 31 which facilitates inserting or screwing-in of the compensating element 31 in the fastening opening 28. While on the right side the connecting element 8 is shown expanded, the assembly is shown on the left side of the figure wherein the thread of the tensile screw 21 protrudes out of the cylinder-shaped compensating element 31. The end of the cylinder-shaped compensating element 31 in turn protrudes out of the welded-on bushing 26 which itself stands away from the engine block bracket 5. Thus with the help of this third embodiment a wide gap can be created between engine block and engine block bracket 5 and varied in its gap width, which supports the thermal decoupling.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A catalytic converter fastening for a combustion engine, comprising:
an engine block bracket releasably connected to an engine block and configured to hold the catalytic converter at a distance to the engine block;
a catalytic converter support connected to the catalytic converter; and
connecting elements configured to releasably connect the engine block bracket to the engine block;
wherein the catalytic converter support comprises an arm that is angled-off towards the engine block bracket,
wherein on the arm an angled-off strap is arranged that is materially connected to a catalytic converter housing, and
wherein the catalytic converter fastening of the engine block bracket and the catalytic converter support is a unitary part.

2. The catalytic converter fastening according to claim 1, wherein the angled-of strap of the catalytic converter support is matched to a contour of the catalytic converter housing and materially connected to the catalytic converter housing.

3. The catalytic converter fastening according to claim 2, wherein the engine block bracket is matched to a second contour of the engine block.

4. The catalytic converter fastening according to claim 3, wherein the engine block bracket comprises bores configured to receive the connecting elements for releasably connecting the catalytic converter fastening to the engine block.

5. The catalytic converter fastening according to claim 4, wherein the engine block bracket comprises elongated holes configured to receive the connecting elements for the releasably connecting of the catalytic converter fastening to the engine block.

6. The catalytic converter fastening according to claim 5, wherein the connecting elements comprise compensating washers for compensating manufacturing tolerances of the catalytic converter fastening and for compensating heat expansions.

7. The catalytic converter fastening according to claim 6, wherein the compensating washers comprise an outer contour on an outer circumference that is substantially matched to a thickness of the engine block bracket and the contour of the bores

8. The catalytic converter fastening according to claim 6, wherein the compensating washers comprise an outer contour on an outer circumference that is substantially matched to a thickness of the engine block bracket and the contour of the elongated holes.

9. The catalytic converter fastening according to claim 6, wherein the compensating washers comprise a resilient plastic.

10. The catalytic converter fastening according to claim 6, wherein the compensating washers comprise a resilient metal.

11. The catalytic converter fastening according to claim 6, wherein the compensating washers comprise a resilient metal.

12. The catalytic converter fastening according to claim 6, wherein the compensating washers comprise a metal alloy.

13. The catalytic converter fastening according to claim 6, wherein the elongated holes in the engine block bracket are vertically open towards the bottom and the engine block bracket is configured to push onto the connecting elements on the engine block with the elongated holes open towards the bottom.

14. The catalytic converter fastening according to claim 1, wherein on the engine block bracket, space-holding molded-on passages are arranged in a region of fastening openings of the engine block bracket.

15. The catalytic converter fastening according to claim 1, wherein on the engine block bracket, welded-on bushings are arranged in a region of fastening openings of the engine block bracket.

16. The catalytic converter fastening according to claim 14, wherein in the space-holding molded-on passages are arranged for cylinder-shaped compensating elements for compensating manufacturing tolerances of the catalytic converter fastening and for compensating heat expansions.

17. The catalytic converter fastening according to claim 15, wherein in the welded-on bushings, cylinder-shaped compensating elements are provided for compensating manufacturing tolerances of the catalytic converter fastening and for compensating heat expansions are arranged.

18. The catalytic converter fastening according to claim 14,
wherein the space-holding molded-on passages have inner threads, and
wherein the cylinder-shaped compensating elements comprise outer threads are screwed into the inner threads.

19. The catalytic converter fastening according to claim 18, wherein the cylinder-shaped compensating elements comprise a resilient plastic.

20. The catalytic converter fastening according to claim 18, wherein the cylinder-shaped compensating elements comprise a resilient metal.
